(19) United States
(12) Patent Application Publication
(10) Pub. No.: US 2010/0179071 A1
(43) Pub. Date: Jul. 15, 2010

(54) CELL PATTERN AND METHOD FOR PRODUCING THE SAME

(75) Inventors: Chin-Hsiung Hsieh, Taipei City (TW); Yi-You Huang, Taipei City (TW)

Correspondence Address: QUINTERO LAW OFFICE, PC, 615 Hampton Dr, Suite A202, Venice, CA, 90291, US

(73) Assignee: NATIONAL TAIWAN UNIVERSITY, Taipei (TW)

(21) Appl. No.: 12/468,814

(22) Filed: May 19, 2009

(30) Foreign Application Priority Data
Jan. 9, 2009 (TW) TW098100580

(51) Int. Cl. C40B 40/02; C40B 50/14

(52) U.S. Cl. 506/14; 506/30

(57) ABSTRACT

A method for producing a cell pattern is provided, comprising the step of forming a hydrophobic film on a substrate, patterning the hydrophobic film by a laser beam, transferring the hydrophobic film from the substrate to a medium, and culturing cells on the medium to form a cell pattern.

### CROSS REFERENCE TO RELATED APPLICATIONS

This application claims the benefit of Taiwan application No. 098100580, filed Jan. 9, 2009.

### BACKGROUND OF THE INVENTION

1. Field of the Invention

The present invention relates to a method for producing patterns on a hydrophobic film, and in particular relates to cell patterns.

2. Description of the Related Art

A cell array is usually fabricated by cell chips using a micro-electrical machine process. The process coats photoresist materials uniformly on a silicon wafer and irradiates the photoresist materials by UV light through a photomask with a specific pattern. After subsequent processes of developing, etching and removing of the photoresist, a template is formed and transferred to a mold. The mold with a specific pattern is used to culture cells, and a cell patterns was obtained (see Taiwan Patent No. 1225660). However, the process uses expensive apparatuses and is complicated.

Taiwan Patent No. 1225660 discloses a protein array region produced by precisely dotting protein on a carrier coated with at least one coating layer surface containing aldehyde functional groups. The protein is dotted by an arrayer. However, the arrayer is expensive. WO2007139144 discloses a cell chip comprising a film with several honeycomb-like pores, produced by water-insoluble polymer by controlling wind velocity, relative humidity and solvent evaporation velocity. Human hepatocytes are retained in the through-pores of a single or both surfaces of the film. However, the process is complicated and the shape or arrangement of the pores is rather fixed.

Therefore, a novel method for producing a cell array is desired. The invention provides an effective method to fabricate a cell array, wherein flexibility is offered for design features, size, and arrangement of cell patterns, operation is simplified when compared to conventional methods, and mass production is available with relatively fast fabrication time.

### BRIEF SUMMARY OF THE INVENTION

One embodiment of the invention provides a method for producing a cell pattern, comprising forming a hydrophobic film on a substrate, patterning the hydrophobic film by a laser beam, transferring the hydrophobic film from the substrate to a medium, and culturing cells on the medium to form a cell pattern.

Another embodiment of the invention provides a cell pattern produced by the method described above.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A illustrates a PDMS film with pores;

FIG. 1B illustrates fibroblasts cultured in a medium attached with the PDMS film of FIG. 1A;

FIG. 1C illustrates a cell pattern by removing the PDMS film of FIG. 1A from the medium.

FIG. 2A illustrates a PDMS film with pores;

FIG. 2B illustrates fibroblasts cultured in a medium attached with the PDMS film of FIG. 2A;

FIG. 2C-1-2C-2 illustrates a cell pattern by removing the PDMS film of FIG. 2A from the medium.

FIG. 3A illustrates a PDMS film with pores;

FIG. 3B illustrates fibroblasts cultured in a medium attached with the PDMS film of FIG. 3A;

FIG. 3C illustrates a cell pattern by removing the PDMS film of FIG. 3A from the medium.

FIG. 4A illustrates a PDMS film with pores;

FIG. 4B illustrates fibroblasts cultured in a medium attached with the PDMS film of FIG. 4A;

FIG. 4C illustrates a cell pattern by removing the PDMS film of FIG. 4A from the medium.

FIG. 5A illustrates a PDMS film with pores;

FIG. 5B illustrates fibroblasts cultured in a medium attached with the PDMS film of FIG. 5A;

FIG. 5C illustrates a cell pattern by removing the PDMS film of FIG. 5A from the medium.

FIG. 6A illustrates a PDMS film with pores;

FIG. 6B illustrates fibroblasts cultured in a medium attached with the PDMS film of FIG. 6A;

FIG. 6C illustrates a cell pattern by removing the PDMS film of FIG. 6A from the medium.

FIG. 7A illustrates a PDMS film with pores;

FIG. 7B illustrates fibroblasts cultured in a medium attached with the PDMS film of FIG. 7A;

FIG. 7C illustrates a cell pattern by removing the PDMS film of FIG. 7A from the medium.

FIG. 8A illustrates a PDMS film with pores;

FIG. 8B illustrates fibroblasts cultured in a medium attached with the PDMS film of FIG. 8A;

FIG. 8C illustrates a cell pattern by removing the PDMS film of FIG. 8A form the medium.

FIG. 9A illustrates a PDMS film with pores;

FIG. 9B illustrates fibroblasts cultured in a medium attached with the PDMS film of FIG. 9A;

FIG. 9C illustrates a cell pattern by removing the PDMS film of FIG. 9A from the medium.

FIG. 10A illustrates a PDMS film with pores;

FIG. 10B illustrates fibroblasts cultured in a medium attached with the PDMS film of FIG. 10A;

FIG. 10C illustrates a cell pattern by removing the PDMS film of FIG. 10A from the medium.

FIG. 11A illustrates a PDMS film with columns;

FIG. 11B illustrates fibroblasts cultured in a medium attached with the PDMS film of FIG. 11A;

FIG. 11C illustrates a cell pattern by removing the PDMS film of FIG. 11A from the medium.

FIG. 12A illustrates a PDMS film with triangles;

FIG. 12B illustrates fibroblasts cultured in a medium attached with the PDMS film of FIG. 12A.

FIG. 13A illustrates a PDMS film with rectangles;

FIG. 13B illustrates fibroblasts cultured in a medium attached with the PDMS film of FIG. 13A.

FIG. 14A illustrates a PDMS film with pores;

FIG. 14B illustrates fibroblasts cultured in a medium attached with the PDMS film of FIG. 14A.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The method for producing a cell pattern of the invention provides a step of forming a hydrophobic film on a substrate. The hydrophobic film of the invention may be polymers with hydrophobic properties and bio-compatibility without specific limitations. The hydrophobic film may be composed of one of a polydimethylsiloxane (PDMS), polyvinylchloride (PVC), polytetrafluoroethylene (PTFE), and poly(lactide-co-glycolide) (PLGA), or combinations thereof. In one embodiment, polydimethysiloxane (PDMS) is preferably used to fabricate the hydrophobic film because of its good thermal stability, low oxidation, soft molecular chain, low glass transition temperature, good oxygen penetration and surface tension, and no toxicity.

The substrate of the invention is not limited, provided that it does not work with the hydrophobic film. Exemplary substrates include hydrogels, such as hyaluronic acid hydrogel, collagen hydrogel or gelatin hydrogel; glass, such as Silica, borosilicate glass or silicon wafer; plastics, such as polystyrene, polypropylene, polyethylene, polyvinyl chloride or polytetrafluoroethylene; and metals, such as Au, Ag or Pt; or other materials.

In one embodiment of the invention, the hydrophobic film is fabricated by a spin coating process at a speed of 100 rpm-10,000 rpm, preferably 500 rpm. The thickness of the film depends on the speed and time of the spin coating process. In one embodiment of the invention, the thickness of the film is preferably 10 nm-1 mm, more preferably 100 μm-500 μm. The spin coater may be self-made or commercially available.

The hydrophobic film is subsequently patterned by a laser beam. The laser beam may be a CO₂ laser, excimer laser, H⁺ ion laser or HF laser, or other laser beams. It may be irradiated by a commercially-available automatic laser device, such as a Laserpro Venus®. In one embodiment, the laser device may further have a gas evacuator to reduce gas from adhering to the hydrophobic film after sintering.

The pattern on the hydrophobic film of the invention, if desired, may be freely designed, such as having one or more pores, triangles, columns, rectangles, irregular features or combinations thereof. The pattern may also be freely arranged, for example in an array or random arrangement. In one embodiment, a pattern is drawn by software, such as AutoCAD or CoreDRAW software in a computer system, and then exported to a laser device which connects with the computer system. The laser device may cut various features of the film, for instance, the thickness of the hydrophobic film, by adjusting the power of the laser device, resolution of the laser lens, time for laser-cutting, speed of the laser tips, etc. In one embodiment of the invention, the laser lens has a minimal linear cut resolution of approximately 100 μm. However, patterns with smaller resolutions may be obtained by adjusting the conditions described above.

In one embodiment of the invention, a plurality of pores is patterned on a hydrophobic film, which may have a radius of 1 μm-10 mm, preferably 10 μm-2 mm and size of the pores may be adjusted by modifying, for instance, the thickness of the hydrophobic film, power of the laser device, resolution of the laser lens, time for laser cutting, speed of the laser tips, etc. In general, a laser device with higher resolution cuts smaller pore sizes. Conversely, a laser device with lower resolution can make larger pores.

The patterned hydrophobic film of the invention may further perform a clean step by ultrasound vibration to remove impurities produced during the process.

The patterned hydrophobic film is then put into a medium for cell culture. The cell type is not limited, preferably immobile on the medium, including animal and plant cells, for instance fibroblasts, epithelial cells, muscle cells, smooth muscle cells, endothelial cells, osteoblasts, nerve cells, etc. The medium used in the invention is preferably solid, however the formula may be modified according to cultured cell types.

One embodiment of the invention further comprises a step of removing the hydrophobic film from the medium after a cell pattern is formed.

### EXAMPLE 1

A polydimethylsiloxane (PDMS) solution (DOW CORING SYLGARD®184) was vacuumed to remove air. Then the PDMS solution was poured into a plastic plate with 9-cm diameter. The plastic plate containing the PDMS solution was put onto a spin coater and rotated 10 sec at 500 rpm. After placed on a table and dried, a PDMS film with a thickness of approximately 100-500 μm was obtained.

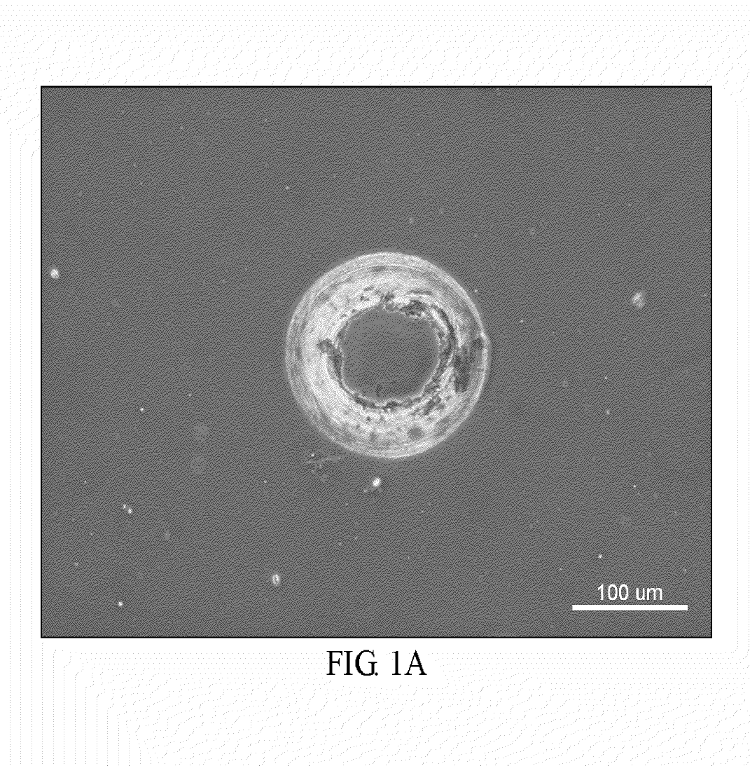

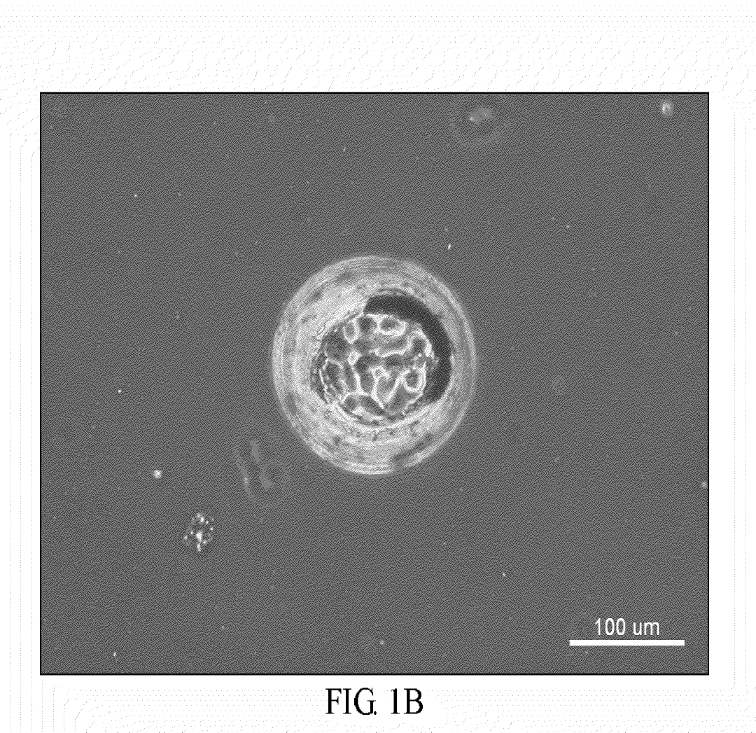

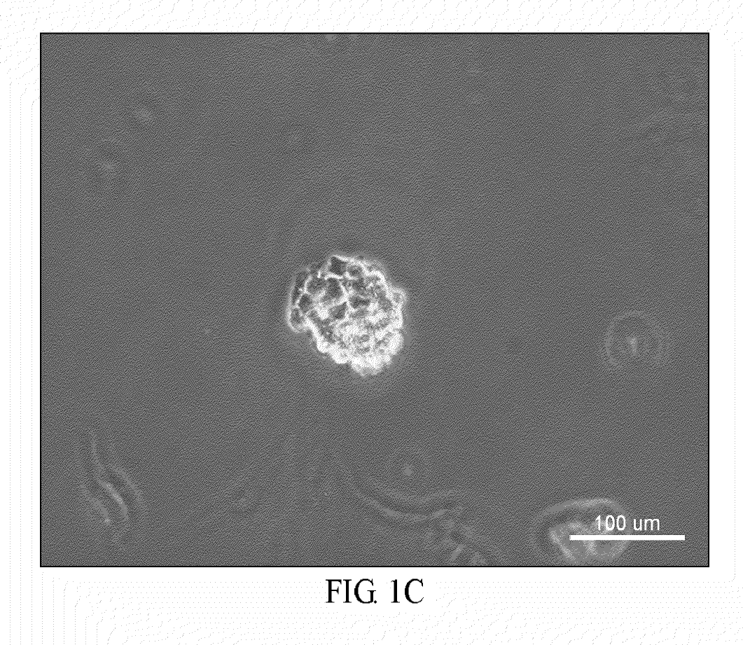

A plurality of dots was drawn by autoCAD software and saved as a graphic file. The file was exported to a laser device (Laserpro Venus® V-30). The laser device was set at 70% of maximum power output and 50% of maximum speed of the laser tip. The film was cut three times. The PDMS film having a plurality of pores with a radius of 95 μm-100 μm as shown in FIG. 1A was obtained.

The PDMS film shown as FIG. 1A was moved out from the plastic plate and washed by ultrasound vibration. The film was then transferred to a polystyrene Petri dish (CORNING®) and attached the bottom of the dish. The cell medium containing 1.5 ml of DMEM (Dulbecco's Modified Eagle Medium) (GIBCO®) and 0.5 ml of fibroblasts (10⁵ cell/ml) were added, which was cultured in an incubator with 5% CO₂ at 37° C. (REVCO®) for 24 hrs. The medium was subsequently washed by a phosphate buffer saline (PBS) for several times. A new medium of DMEM was replaced and the cells were allowed to culture for three days. Cells were grown in the pores to form a cell pattern. Subsequently, an inverted microscopy (Olympus IX70) was used to photograph the medium at 40×. A portion of the cell pattern is shown in FIG. 1B. Afterward, the PDMS film was removed and another photo was taken again. The cell pattern was illustrated in FIG. 1C.

### EXAMPLE 2

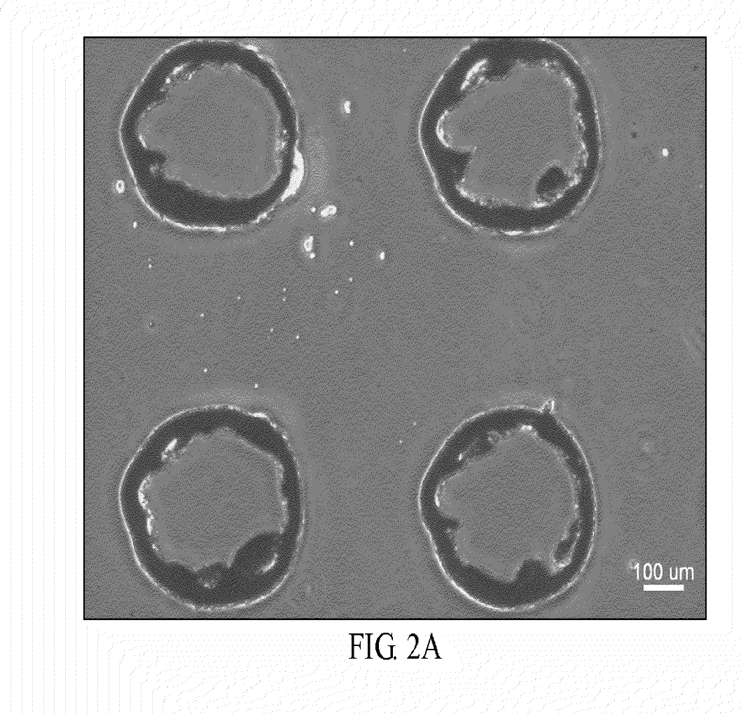

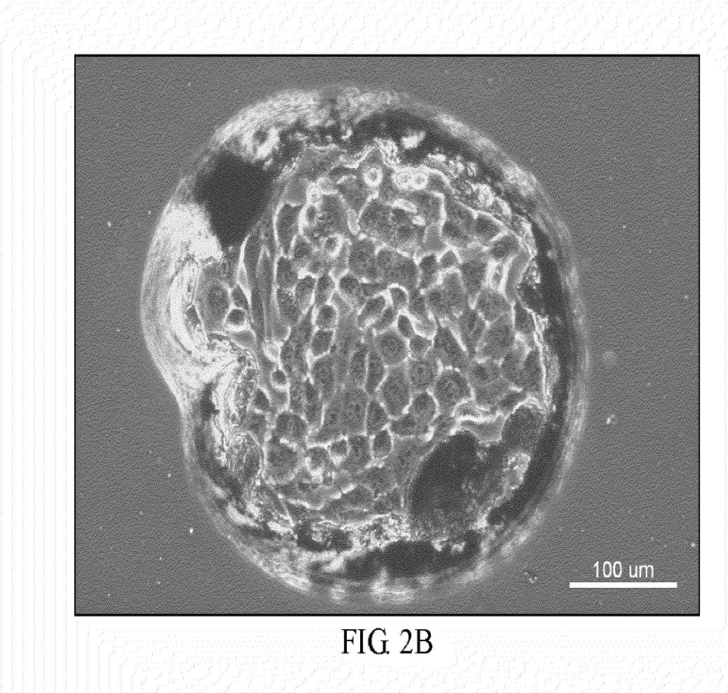

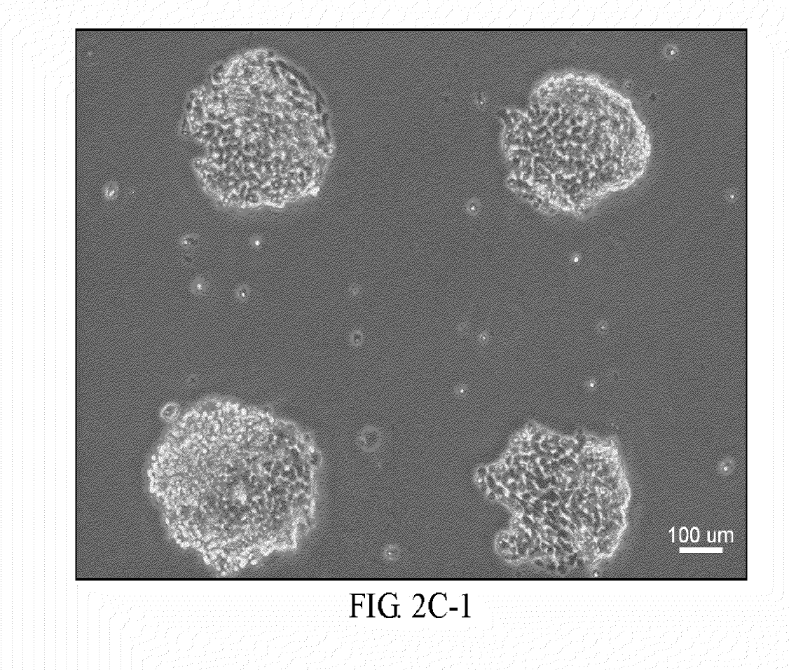

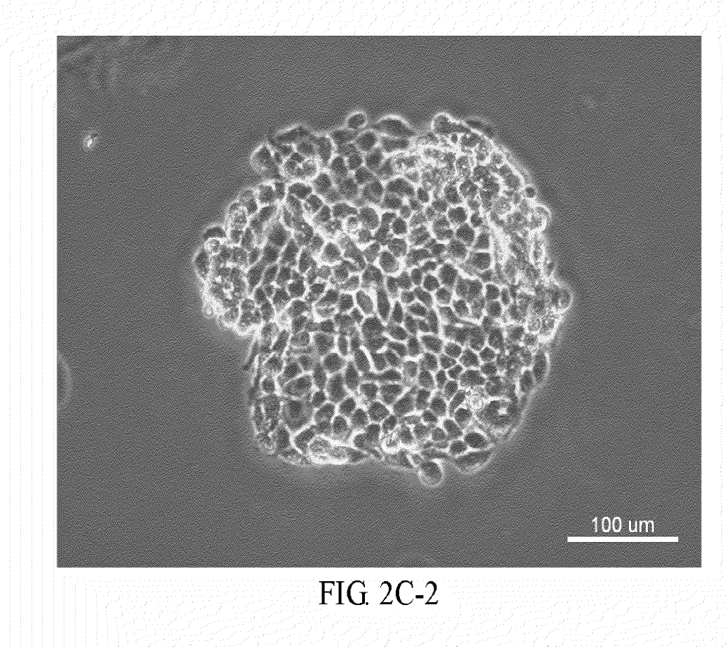

The process herein was similar to that in Example 1, however, pores with a radius of 250 μm were drawn instead. After laser cutting, the PDMS film having a plurality of pores with a radius of 290 μm-310 μm as shown in FIG. 2A was obtained. The PDMS film of FIG. 2A was then used to culture the fibroblasts on the medium and a portion of the cell pattern was provided as shown in FIG. 2B. Then the PDMS film was removed, with the cell pattern obtained was as shown in FIG. 2C-1 and FIG. 2C-2.

### EXAMPLE 3

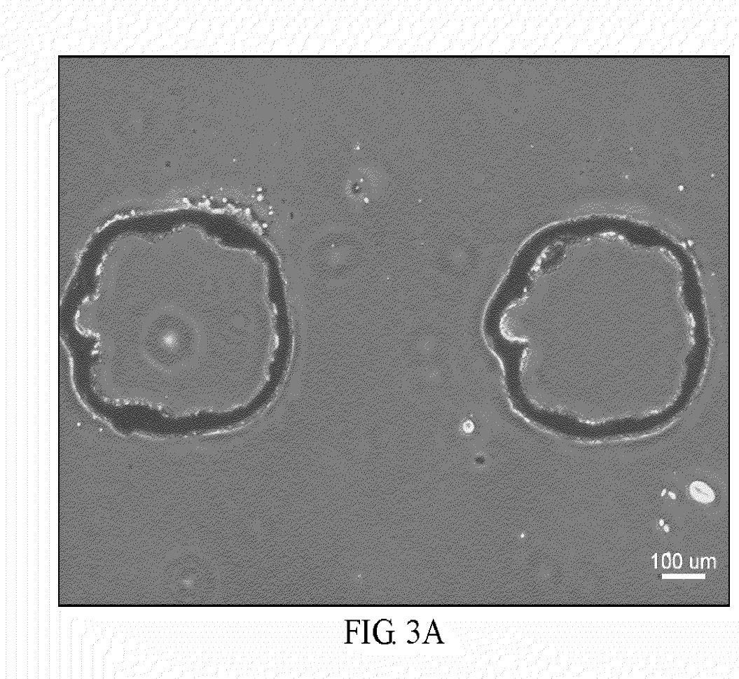

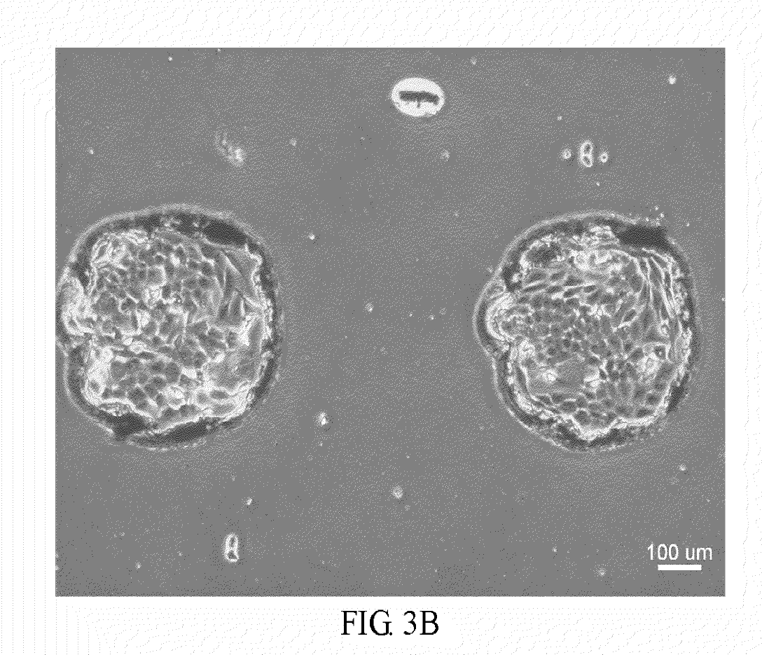

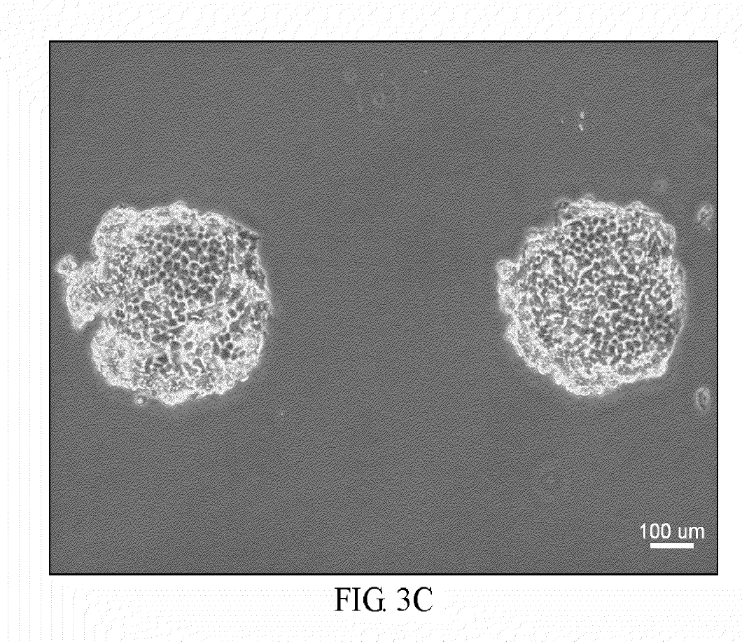

The process herein was similar to that in Example 1, however pores with a radius of 350 μm were drawn instead. After laser cutting, the PDMS film having a plurality of pores with a radius of 360 μm-390 μm as shown in FIG. 3A was obtained. The PDMS film of FIG. 3A was then used to culture fibroblasts on the medium and a portion of the cell pattern was provided as shown in FIG. 3B. The PDMS film was removed from the medium, and a cell pattern was obtained as shown as FIG. 3C.

### EXAMPLE 4

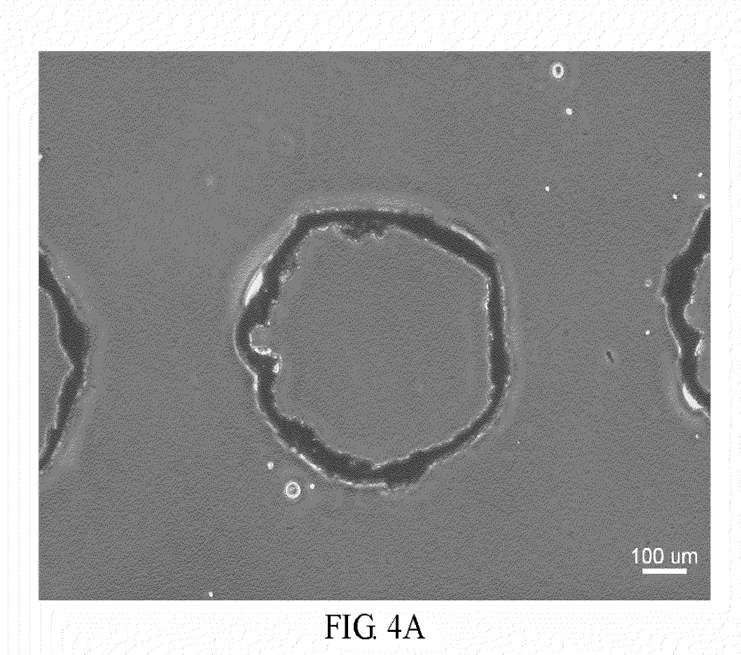

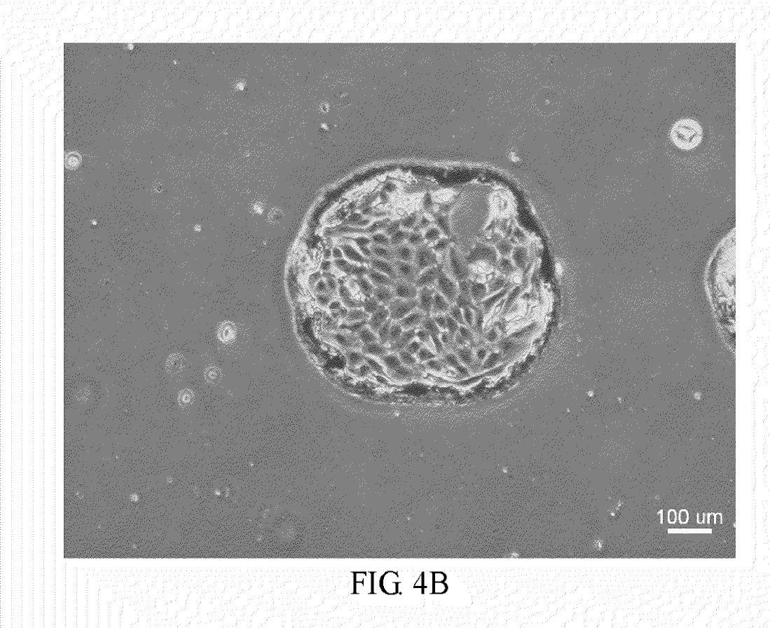

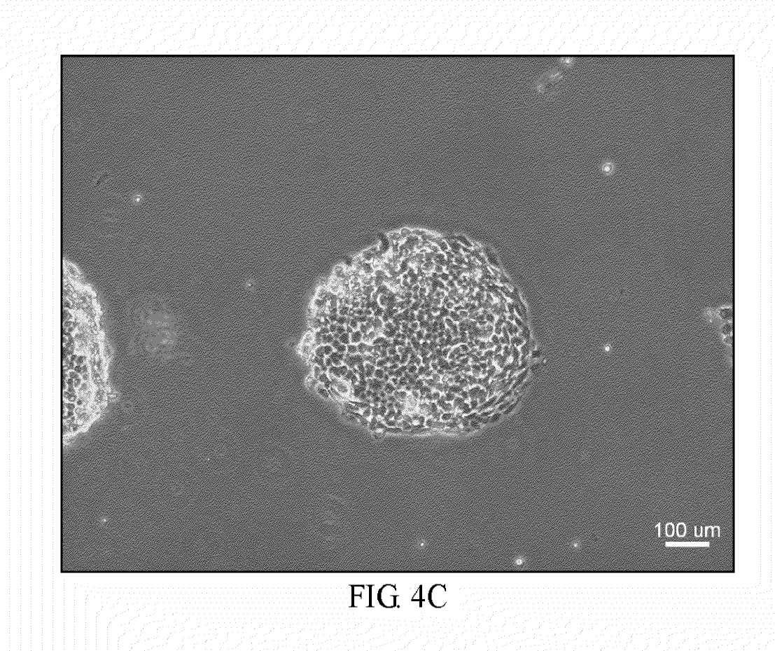

The process herein was similar to that in Example 1, however pores with a radius of 400 μm were drawn instead. After laser cutting, the PDMS film having a plurality of pores with a radius of 430 μm-460 μm as shown in FIG. 4A was obtained. The PDMS film of FIG. 4A was then used to culture fibroblasts on the medium and a portion of the cell pattern was provided as shown in FIG. 4B. The PDMS film was removed, and a cell pattern was obtained as shown as FIG. 4C.

### EXAMPLE 5

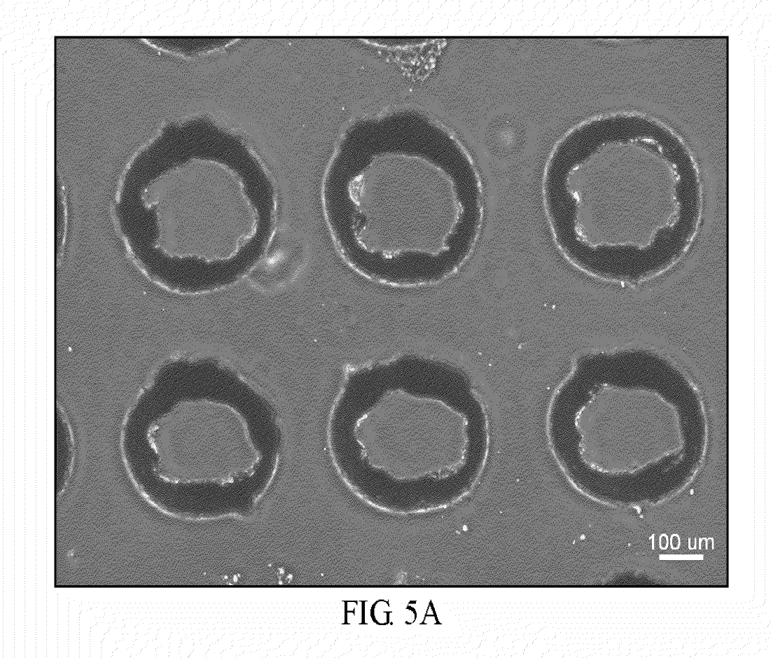

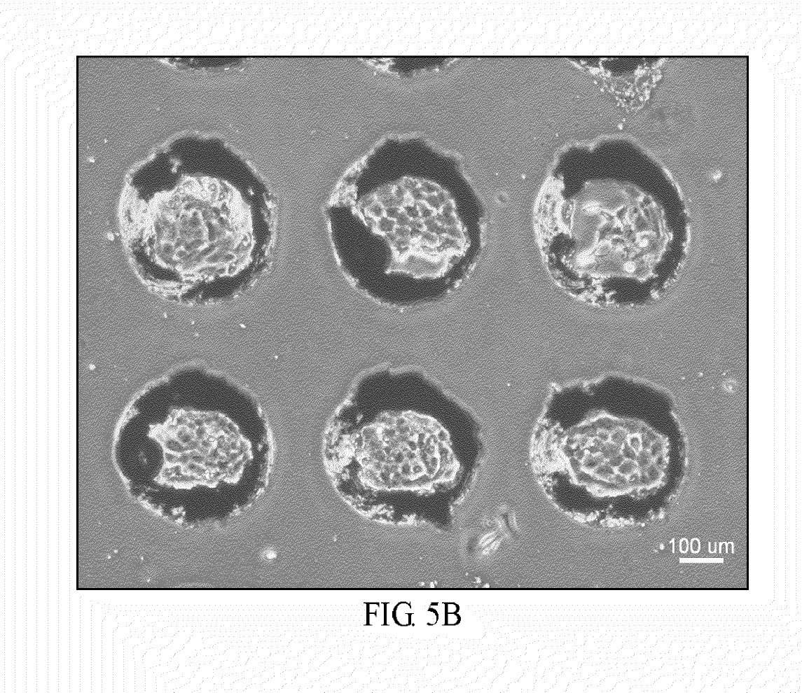

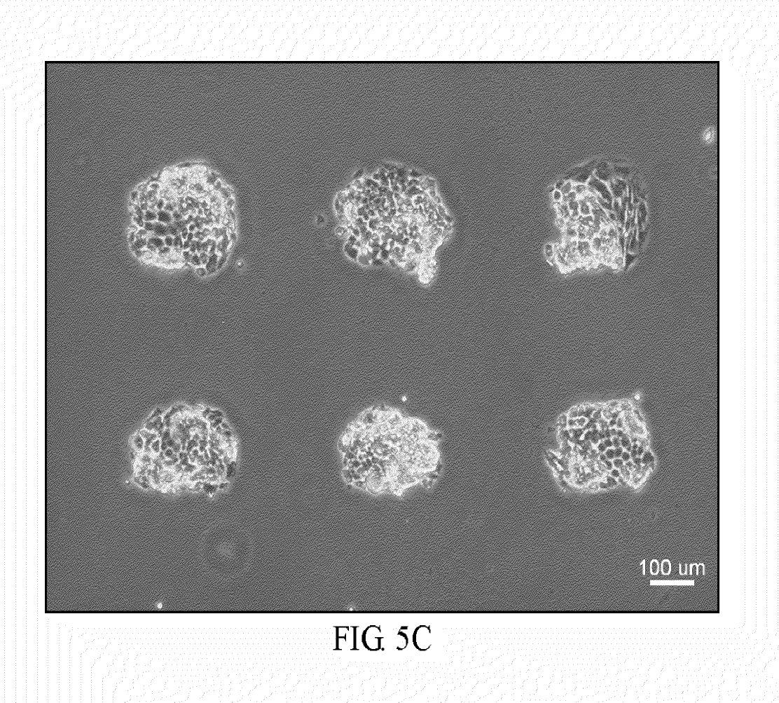

The process herein was similar to that in Example 1, however pores with a radius of 150 μm were drawn instead. After laser cutting, the PDMS film having a plurality of pores with a radius of 200 μm-230 μm as shown in FIG. 5A was obtained. The PDMS film of FIG. 5A was then used to culture fibroblasts on the medium and a portion of the cell pattern was provided as shown in FIG. 5B. The PDMS film was removed, and a cell pattern was obtained as shown as FIG. 5C.

### EXAMPLE 6

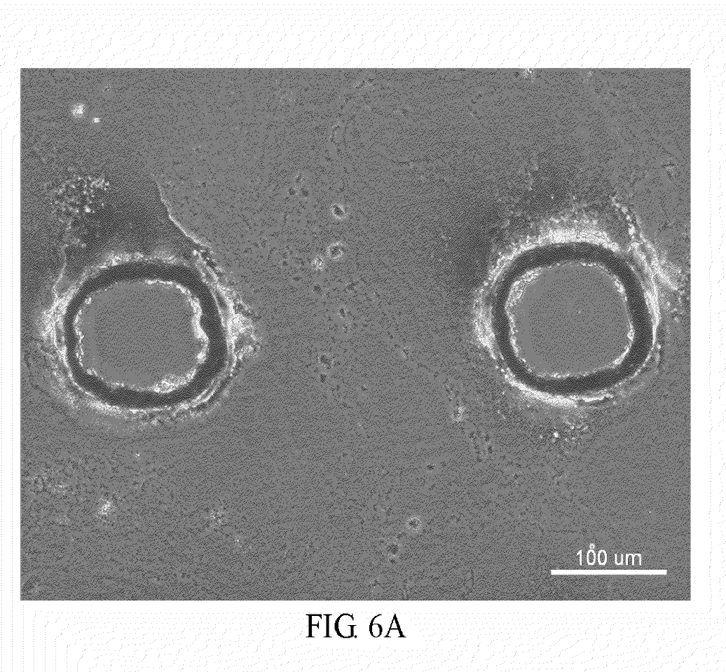

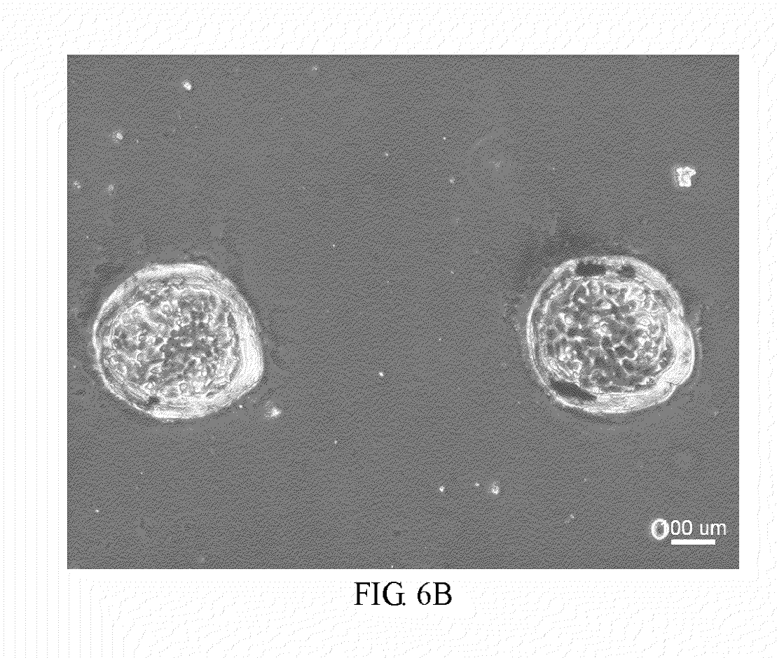

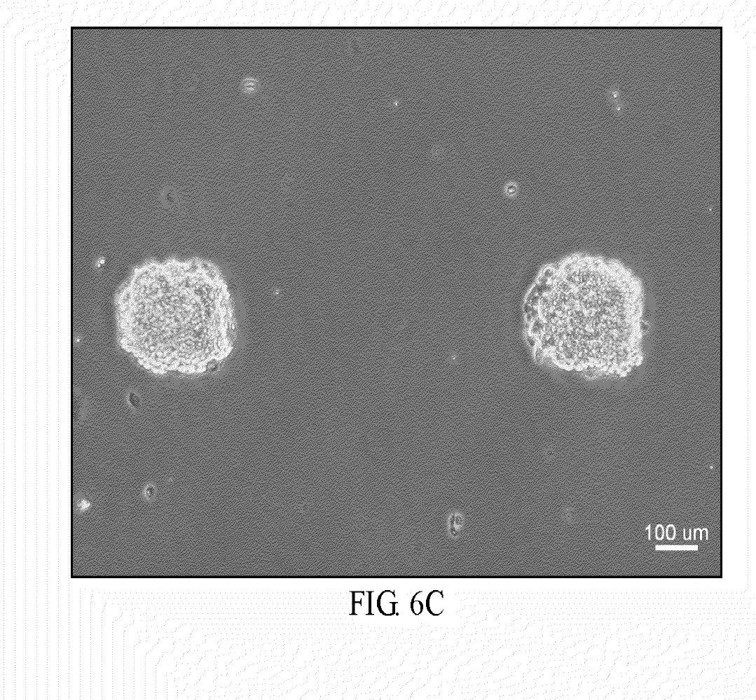

The process herein was similar to that in Example 1, however pores with a radius of 220 μm were drawn instead. After laser cutting, the PDMS film having a plurality of pores with a radius of 230 μm-260 μm as shown in FIG. 6A was obtained. The PDMS film of FIG. 6A was then used to culture fibroblasts on the medium and a portion of the cell pattern was provided as shown in FIG. 6B. The PDMS film was removed, and a cell pattern was obtained as shown as FIG. 6C.

### EXAMPLE 7

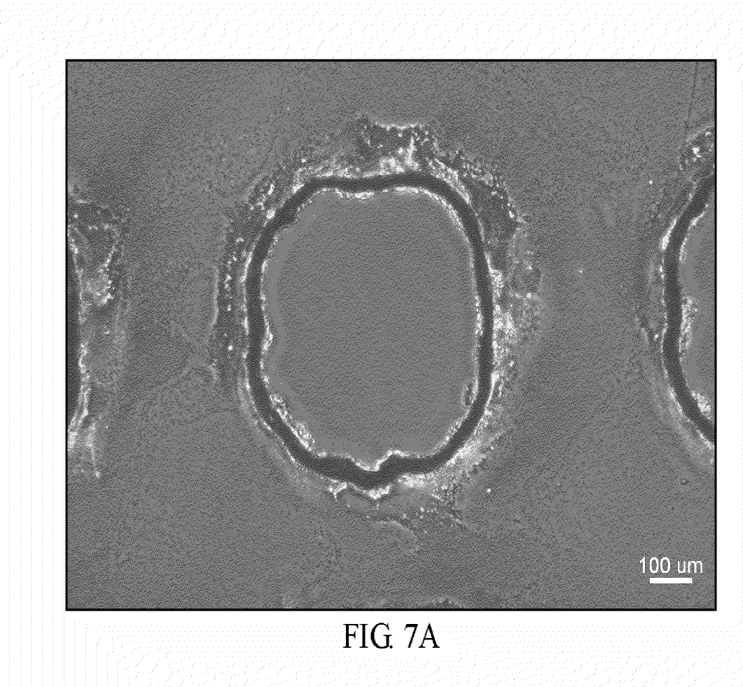

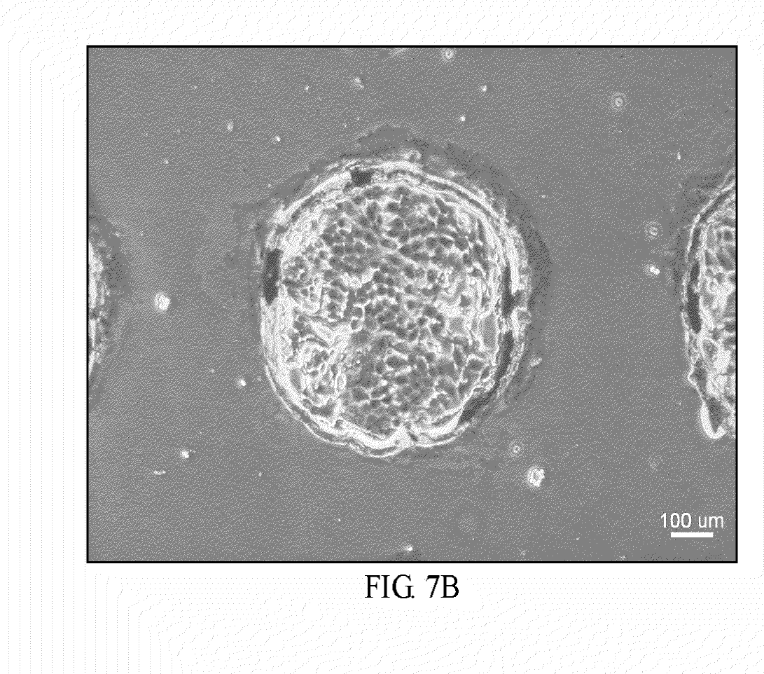

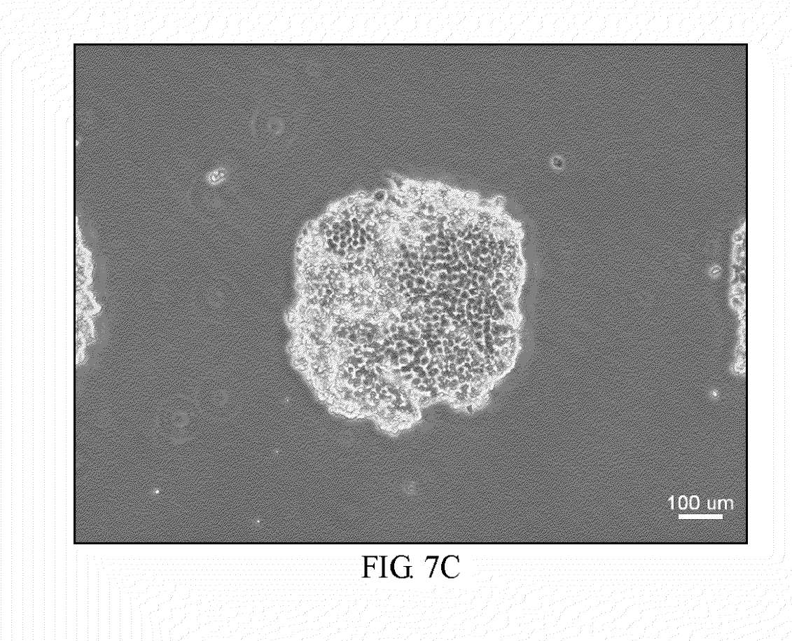

The process herein was similar to that in Example 1, however pores with a radius of 420 μm were drawn instead. After laser cutting, the PDMS film having a plurality of pores with a radius of 450 μm-500 μm as shown in FIG. 7A was obtained. The PDMS film of FIG. 7A was then used to culture fibroblasts on the medium and a portion of the cell pattern was provided as shown in FIG. 7B. The PDMS film was removed, and a cell pattern was obtained as shown as FIG. 7C.

### EXAMPLE 8

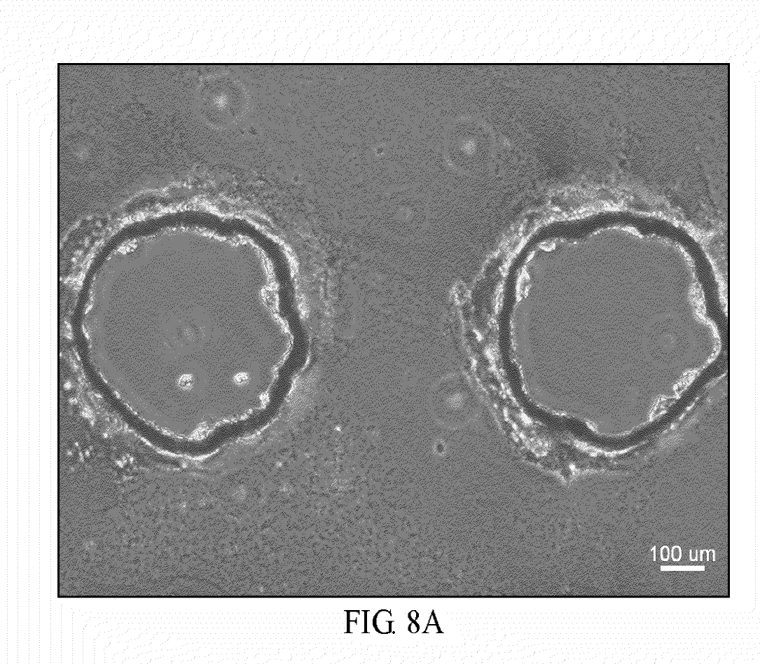

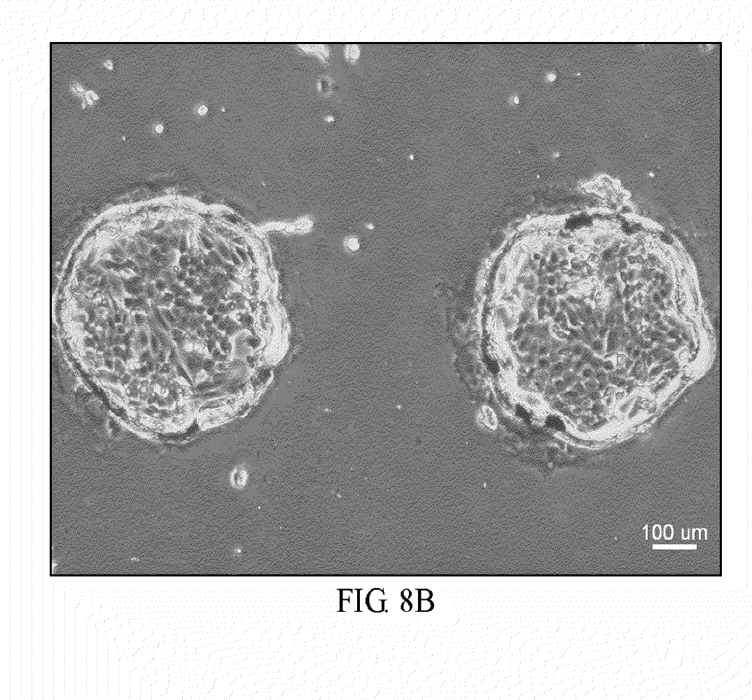

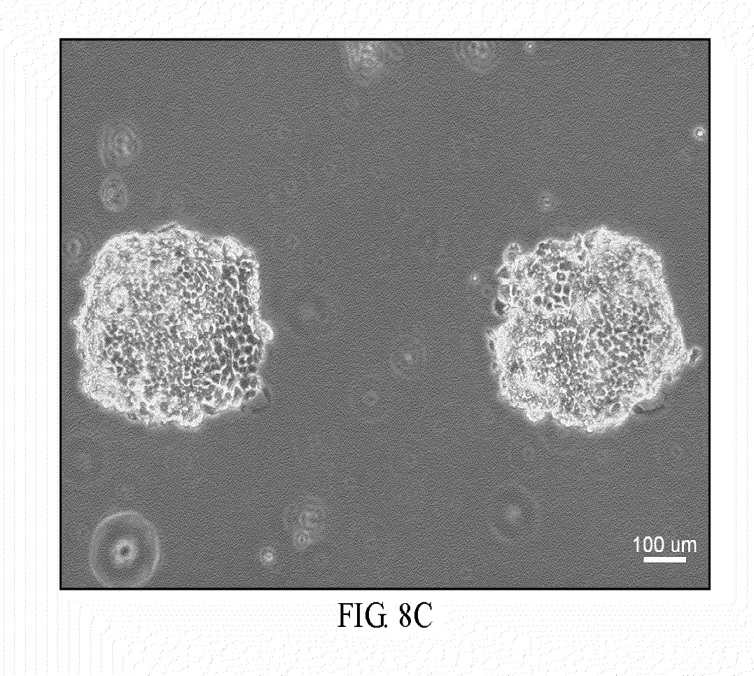

The process herein was similar to that in Example 1, however pores with a radius of 370 μm were drawn instead. After laser cutting, the PDMS film having a plurality of pores with a radius of 380 μm-410 μm as shown in FIG. 8A was obtained. The PDMS film of FIG. 8A was then used to culture fibroblasts on the medium and a portion of the cell pattern was provided as shown in FIG. 8B. The PDMS film was removed, and a cell pattern was obtained as shown as FIG. 8C.

### EXAMPLE 9

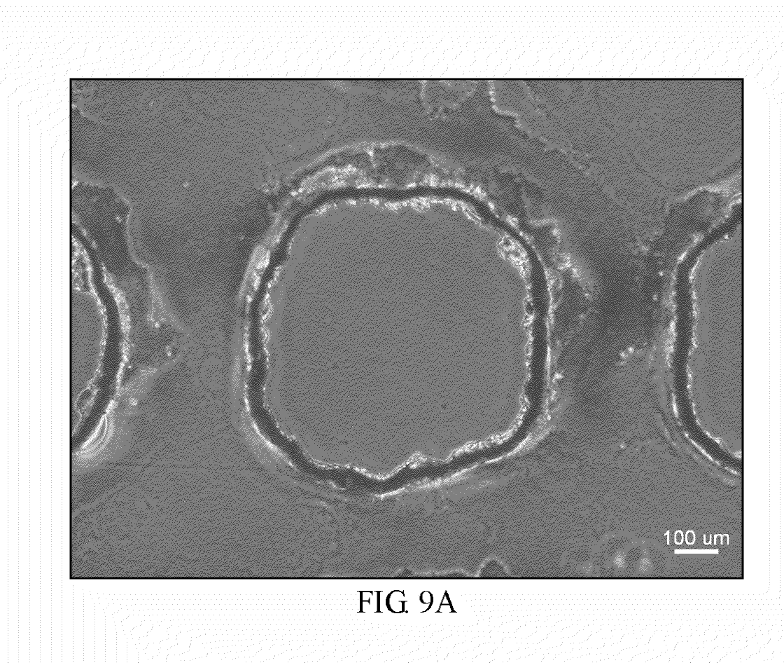

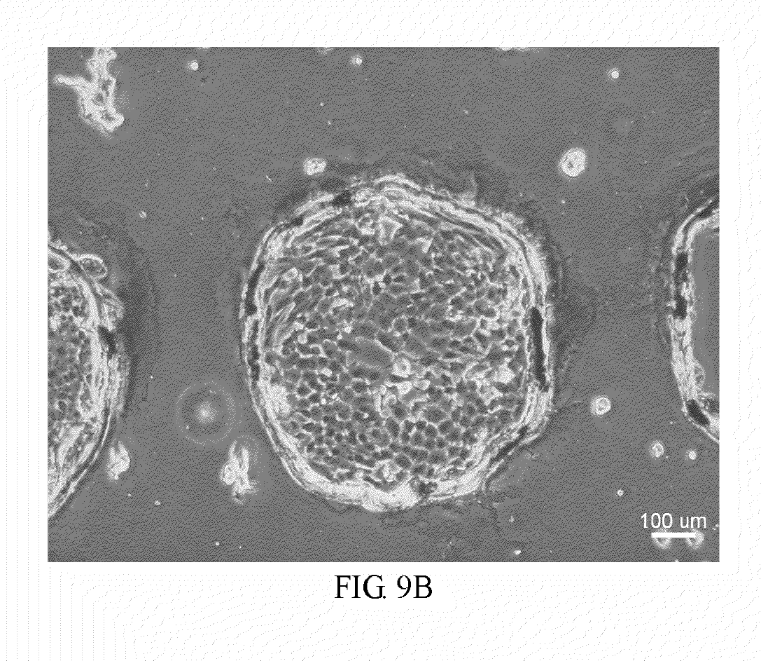

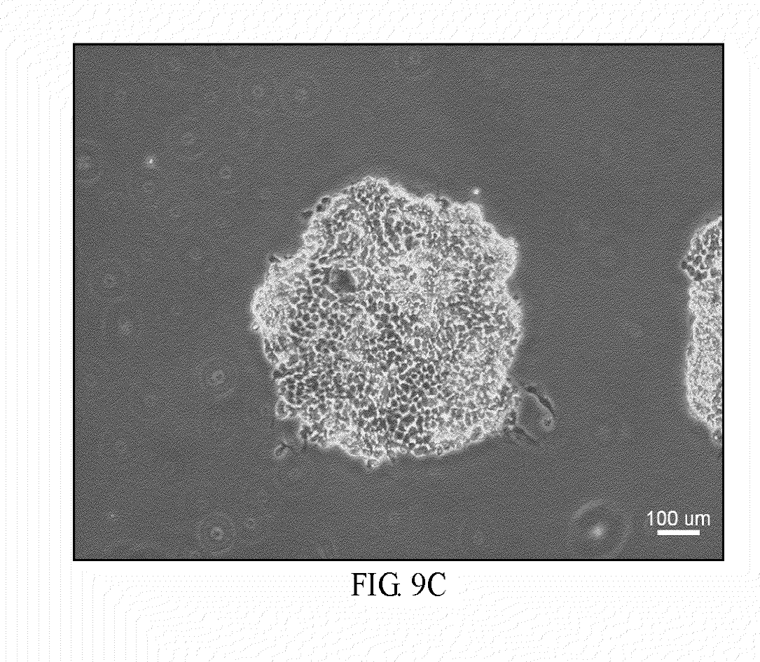

The process herein was similar to that in Example 1, however pores with a radius of 500 μm were drawn instead. After laser cutting, the PDMS film having a plurality of pores with a radius of 520 μm-560 μm as shown in FIG. 9A was obtained. The PDMS film of FIG. 9A was then used to culture fibroblasts on the medium and a portion of the cell pattern was provided as shown in FIG. 9B. The PDMS film was removed, and a cell pattern was obtained as shown as FIG. 9C.

### EXAMPLE 10

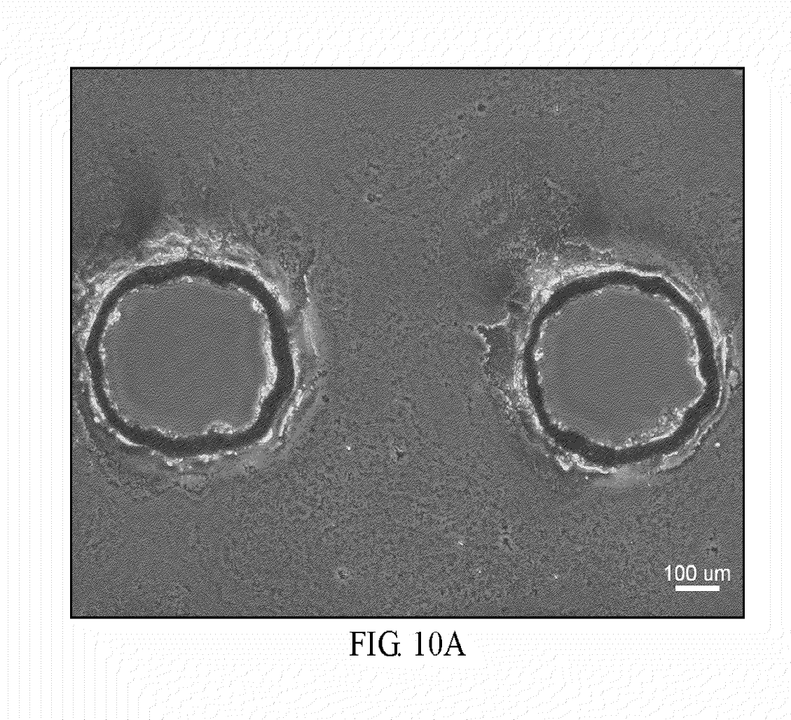

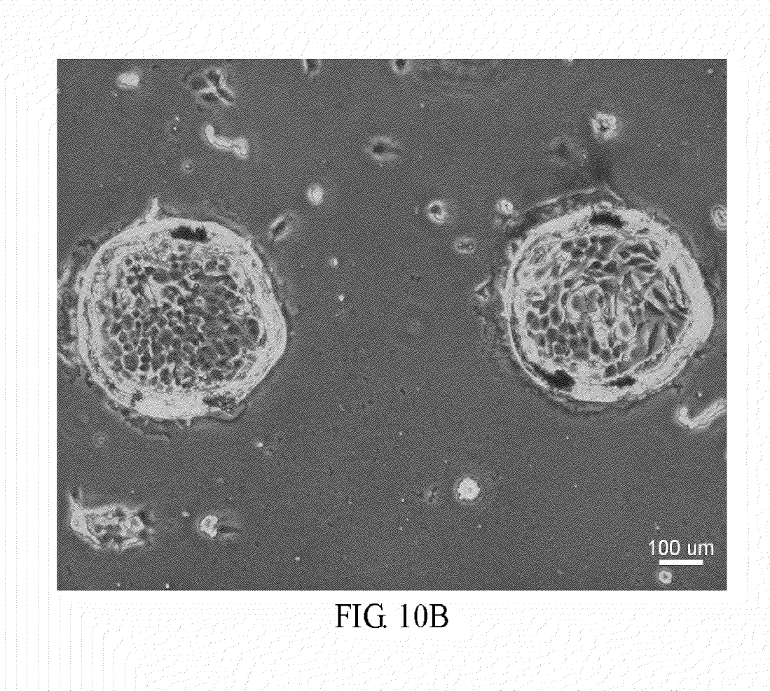

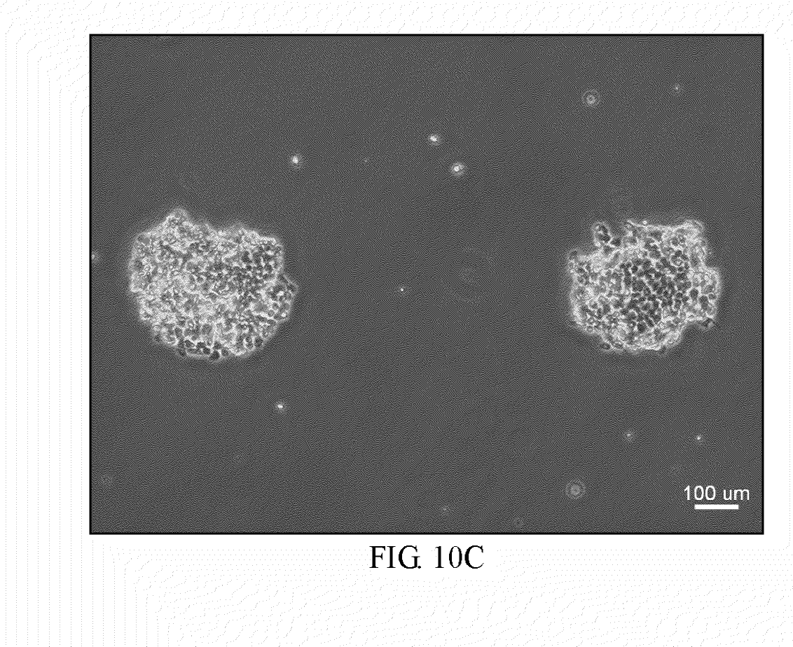

The process herein was similar to that in Example 1, however pores with a radius of 240 μm were drawn instead. After laser cutting, the PDMS film having a plurality of pores with a radius of 290 μm-330 μm as shown in FIG. 10A was obtained. The PDMS film of FIG. 10A was then used to culture fibroblasts on the medium and a portion of the cell pattern was provided as shown in FIG. 10B. The PDMS film was removed, and a cell pattern was obtained as shown as FIG. 10C.

### EXAMPLE 11

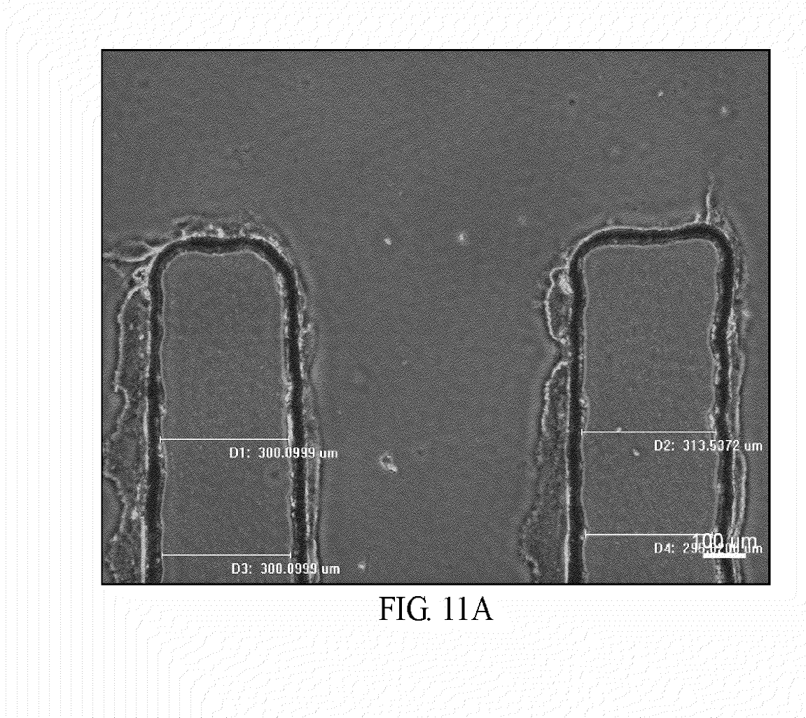

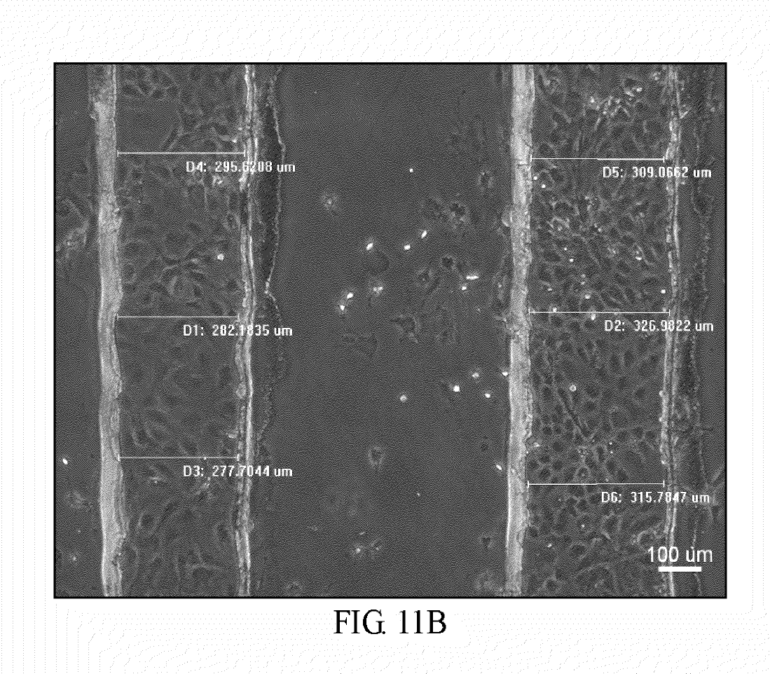

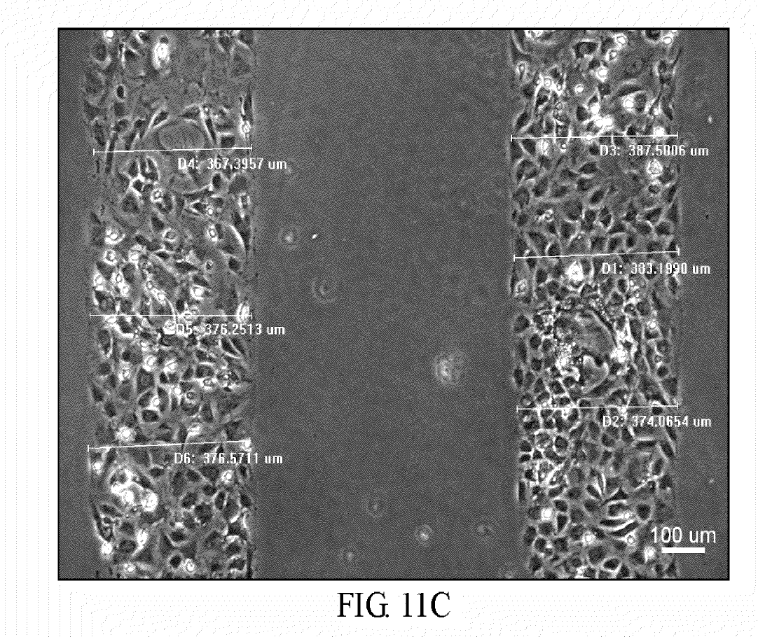

The process herein was similar to that in Example 1, however columns with 1 mm in length and 200 μm in width were drawn instead. After laser cutting, the PDMS film having a plurality of columns with 1 mm-1.1 mm in length and 350 μm-380 μm in width as shown in FIG. 11A was obtained. The PDMS film of FIG. 11A was then used to culture fibroblasts on the medium and a portion of the cell pattern was provided as shown in FIG. 11B. The PDMS film was removed, and a cell pattern was obtained as shown as FIG. 11C.

### EXAMPLE 12

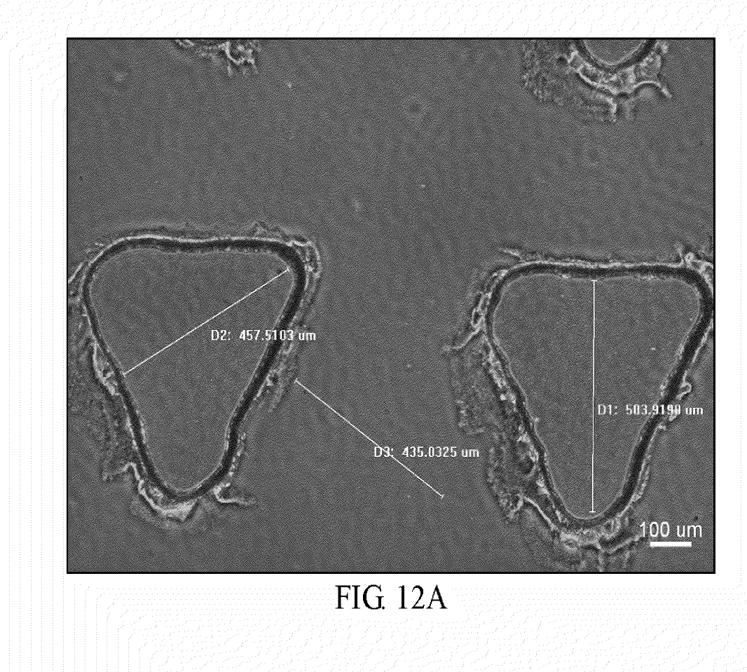

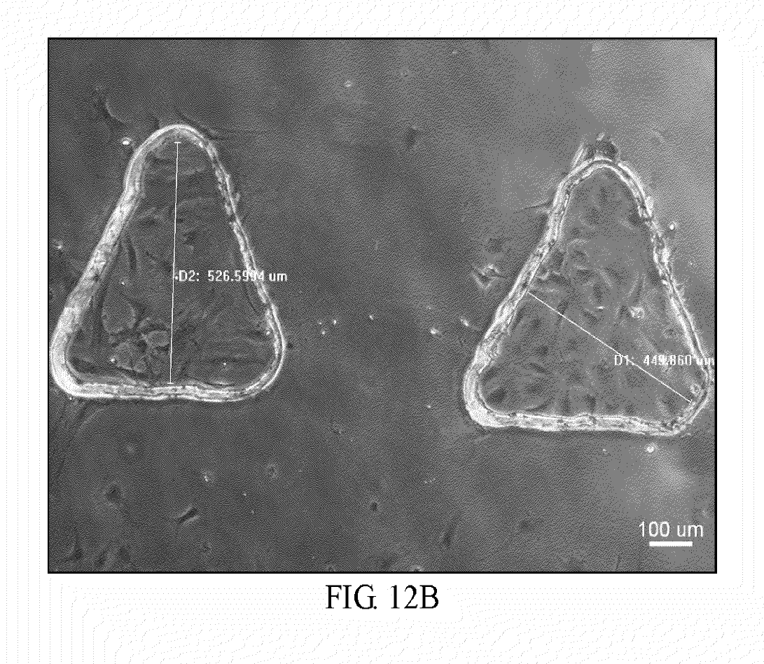

The process herein was similar to that in Example 1, however regular triangles with 300 μm-diameter circumscribed circles were drawn instead. After laser cutting, the PDMS film having a plurality of regular triangles with 440 μm-470 μm in height from a base side and 510 μm-540 μm height from a lateral side as shown in FIG. 12A was obtained. The PDMS film of FIG. 12A was then used to culture fibroblasts on the medium and a portion of the cell pattern was provided as shown in FIG. 12B.

### EXAMPLE 13

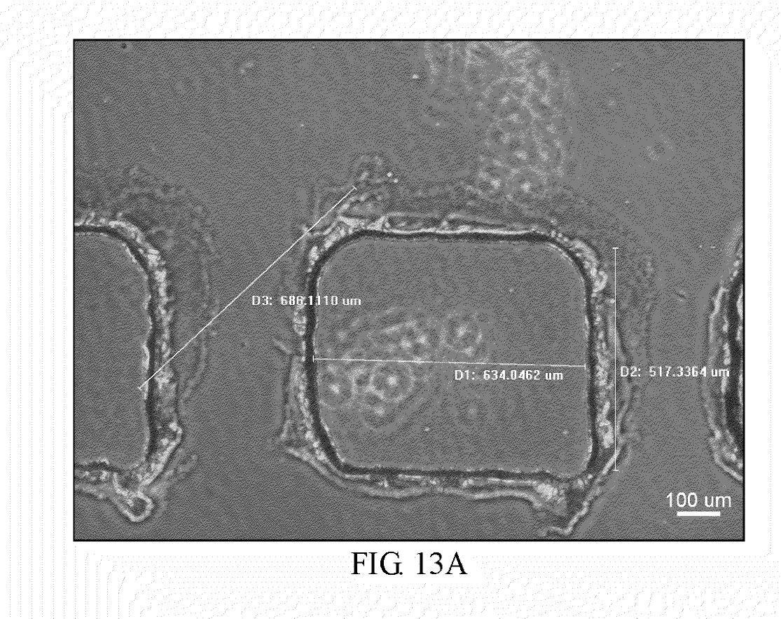

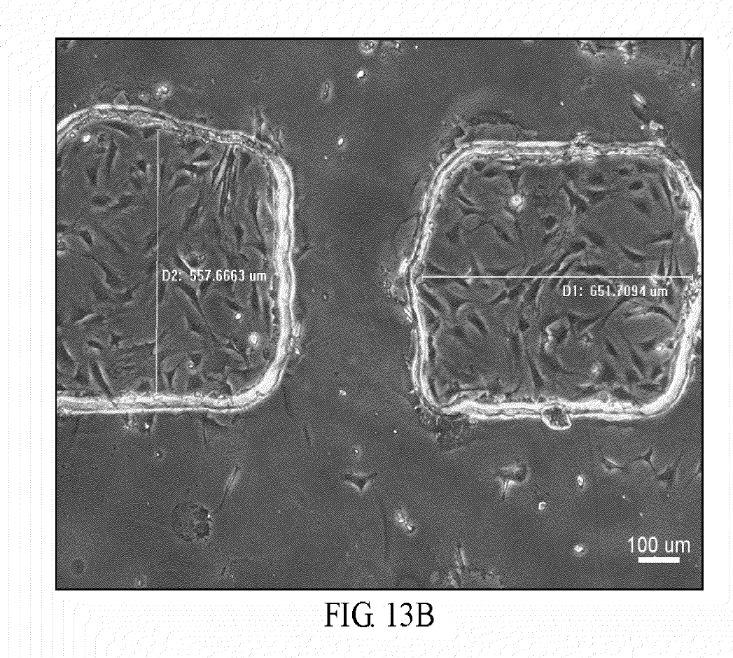

The process herein was similar to that in Example 1, however squares with 400 μm in length were drawn instead. After laser cutting, the PDMS film having a plurality of rectangles having 620 μm-650 μm in length and 510 μm-550 μm in width as shown in FIG. 13A was obtained. The PDMS film of FIG. 13A was then used to culture fibroblasts on the medium and a portion of the cell pattern was provided as shown in FIG. 13B.

### EXAMPLE 14

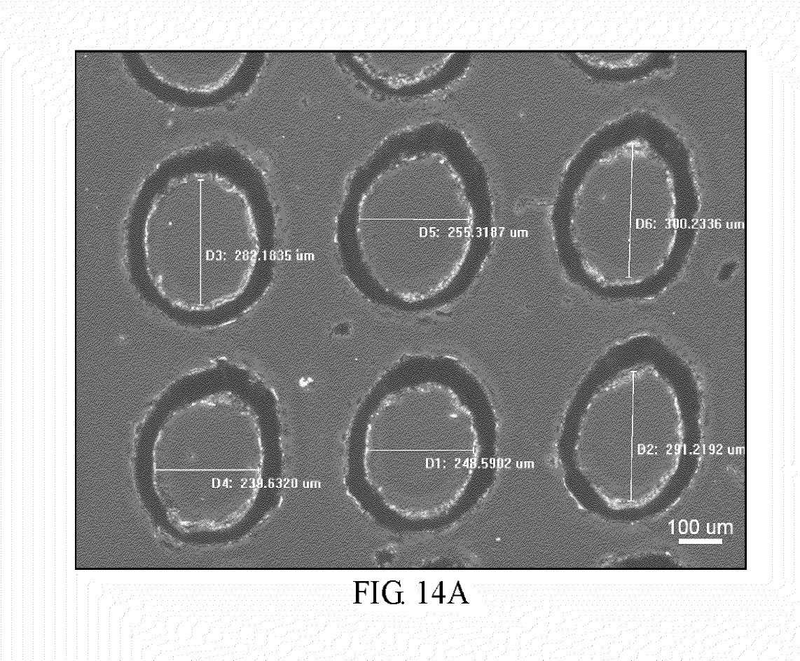

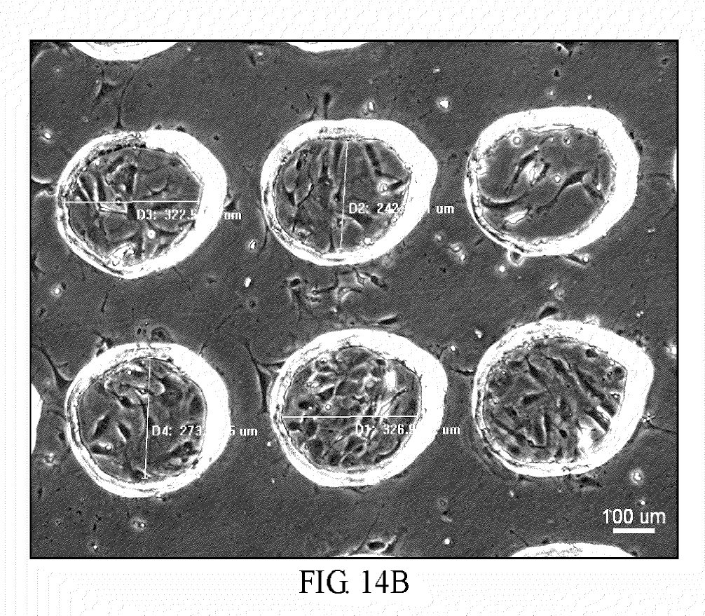

The process herein was similar to that in Example 1, however pores with a radius of 200 μm were drawn instead. After laser cutting, the PDMS film having a plurality of pores with a radius of 240 μm-320 μm as shown in FIG. 14A was obtained. The PDMS film of FIG. 14A was then used to culture fibroblasts on the medium and a portion of the cell pattern was provided as shown in FIG. 14B.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for producing a cell pattern, comprising:
forming a hydrophobic film on a substrate;
patterning the hydrophobic film by a laser beam;
transferring the hydrophobic film from the substrate to a medium; and
culturing cells on the medium to form a cell pattern.

2. The method as claimed in claim 1, wherein the hydrophobic film comprises polydimethylsiloxane (PDMS), polyvinylchloride (PVC), polytetrafluoroethylene (PTFE), poly(lactide-co-glycolide)(PLGA) or combinations thereof.

3. The method as claimed in claim 1, wherein the hydrophobic film is fabricated by a spin coating process.

4. The method as claimed in claim 3, wherein speed of the spin coating process ranges from 100 rpm to 10,000 rpm.

5. The method as claimed in claim 3, wherein speed of the spin coating process is 500 rpm.

6. The method as claimed in claim 1, wherein thickness of the hydrophobic film ranges from 10 nm to 1 mm.

7. The method as claimed in claim 1, wherein thickness of the hydrophobic film ranges from 100 μm to 500 μm.

8. The method as claimed in claim 1, wherein the substrate comprises hydrogels, glass, plastics or metals.

9. The method as claimed in claim 8, wherein the hydrogels comprise hyaluronic acid hydrogel, collagen hydrogel, or gelatin hydrogel.

10. The method as claimed in claim 8, wherein the glass comprises silica, borosilicate glass, or silicon wafer.

11. The method as claimed in claim 8, wherein the plastics comprise polystyrene, polypropylene, polyethylene, polyvinyl chloride or polytetrafluoroethylene.

12. The method as claimed in claim 8, wherein the metals comprise Au, Ag, or Pt.

13. The method as claimed in claim 1, wherein the laser beam comprises CO₂ laser, excimer laser, H⁺ ion laser, or HF laser.

14. The method as claimed in claim 1, further comprising a step of drawing the pattern by software and exporting the pattern to a device providing the laser beam.

15. The method as claimed in claim 14, wherein the software comprises AutoCAD or CoreDRAW software.

16. The method as claimed in claim 14, wherein the device providing the laser beam further comprises a gas evacuator.

17. The method as claimed in claim 1, further comprising a step of cleaning the hydrophobic film by ultrasound.

18. The method as claimed in claim 1, wherein the pattern comprises one or more pores, triangles, columns, rectangles, irregular features, or combinations thereof.

19. The method as claimed in claim 1, wherein the pattern comprises an arrayed arrangement.

20. The method as claimed in claim 1, wherein the pattern comprises a random arrangement.

21. The method as claimed in claim 18, wherein the pore has a radius of 1 μm-10 mm.

22. The method as claimed in claim 18, wherein the pore has a radius of 10 μm-2 mm.

23. The method as claimed in claim 1, wherein the cells are adhesive.

24. The method as claimed in claim 1, wherein the cells comprise fibroblasts, epithelial cells, muscle cells, smooth muscle cells, endothelial cells, osteoblasts, or nerve cells.

25. The method as claimed in claim 1, wherein the medium is solid.

26. The method as claimed in claim 1, further comprising a step of removing the hydrophobic film from the medium.

27. A cell pattern, produced by the method as claimed in claim 1.
